(19) United States
(12) Patent Application Publication
(10) Pub. No.: US 2025/0026954 A1
(43) Pub. Date: Jan. 23, 2025

(54) ANIONIC EXPLOSION-PROOF MEMBRANE AND PREPARATION METHOD THEREFOR

(71) Applicant: HUBEI INSTITUTE OF AEROSPACE CHEMICAL TECHNOLOGY, Xiangyang, Hubei (CN)

(72) Inventors: Ning ZHANG, Xiangyang, Hubei (CN); Jun YAO, Xiangyang, Hubei (CN); Ping XIA, Xiangyang, Hubei (CN); Hongyuan ZHANG, Xiangyang, Hubei (CN); Yan CAI, Xiangyang, Hubei (CN); Guoqi LUO, Xiangyang, Hubei (CN)

(21) Appl. No.: 18/576,480

(22) PCT Filed: Aug. 3, 2022
(86) PCT No.: PCT/CN2022/110016

§ 371 Date: Jun. 11, 2024

(30) Foreign Application Priority Data
Dec. 6, 2021 (CN) 202111481609.1

(51) Int. Cl. C09D 175/14; C08J 7/04; C08J 7/046; C09D 7/61; C09J 7/25; C09J 7/38

(52) U.S. Cl. CPC C09D 175/14; C08J 7/042; C08J 7/046; C09D 7/61; C09J 7/255; C09J 7/385; C09J 2301/122; C09J 2301/302; C09J 2433/00; C09J 2467/006

(57) ABSTRACT

Provided in the present disclosure are an anionic explosion-proof membrane and a preparation method therefor. A surface of the anionic explosion-proof membrane contains two layers of hardened coatings, wherein the hardened coatings respectively contain anionic agent particles with different concentrations and different particle sizes, and a certain gradient is present in the concentrations of the anionic agent. The anionic agent on the inner layer has a relatively high concentration and a relatively large particle size, and the negative ion agent on the outer layer has a relatively low concentration and a relatively small particle size; therefore, the explosion-proof membrane has an efficient and lasting negative ion release capacity.

### CROSS-REFERENCE TO RELATED APPLICATIONS

This application is a United States national phase application, which claims priority to international application no. PCT/CN2022/110016, filed 3 Aug. 2022, which claims the benefit of Chinese patent application no. CN202111481609.1, filed 6 Dec. 2021. The entire contents of each of these applications are hereby incorporated by reference as if fully set forth herein.

### BACKGROUND OF THE INVENTION

### 1. Field of the Invention

The present disclosure relates to the technical field of explosion-proof membranes, and in particular, relates to an anionic explosion-proof membrane and a preparation method therefor.

### 2. Background of the Invention

The explosion-proof membrane attached to the glass can play a wear-resistant, and anti-scratch role, and most importantly, prevent debris resulting of glass burst from harming people.

Bathroom glass, due to being in a relatively humid environment for a long period of time and usually poor bathroom lighting, is prone to growing bacteria. Therefore, the problem of the current explosion-proof membrane to solve urgently is to enable itself to kill bacteria in the bathing environment and purify the air.

### SUMMARY OF THE INVENTION

Thus, there exists a need in the art for an anionic explosion-proof membrane. The anionic explosion-proof membrane of this invention includes a first anion-hardening coating layer and a second anion-hardening coating layer adjacent to each other in sequence, a base film, a mounting adhesive layer, and a release film.

The first anion-hardening coating layer and the second anion-hardening coating layer both contain a water-based polyurethane acrylate oligomer, a photoinitiator, an anion agent, and water.

The amount of water-based anions in the first anion-hardening coating layer is less than the amount of water-based anions in the second anion-hardening coating layer.

The particle diameter of the water-based anions in the first anion-hardening coating layer is smaller than the particle diameter of the water-based anions in the second anion-hardening coating layer.

In some embodiments, the total thickness of the first anion-hardening coating layer and the second anion-hardening coating layer is 2 μm-10 μm.

In some embodiments, the thickness of the first anion-hardening coating layer is 1 μm-5 μm; the particle diameter of the anion agent in the first anion-hardening coating layer is 20 nm-60 nm; and the mass percentage of the anion agent in the first anion-hardening coating layer is 0.01 wt %-0.1 wt %. In some embodiments, the particle diameter of the anion agent in the first anion-hardening coating layer is 20 nm-40 nm.

In some embodiments, the thickness of the second anion-hardening coating layer is 1 μm-5 μm; the particle diameter of the anion agent in the second anion-hardening coating layer is 70 nm-120 nm; and the mass percentage of the anion agent in the second anion-hardening coating layer is 0.2 wt %-0.5 wt %. In some embodiments, the particle diameter of the anion agent in the second anion-hardening coating layer is 80 nm-100 nm.

In some embodiments, the anion agent is produced from the natural mineral tourmaline by ultrafine pulverization, coating modification, and ion exchange doping.

In some embodiments, the material of base film is PET, and the thickness of base film is 20 μm-200 μm. In some embodiments, the thickness of base film is 50 μm-100 μm. In some embodiments, the light transmittance of base film is 85% or more. In some embodiments, the light transmittance of base film is 90% or more.

In some embodiments, the material of the mounting adhesive layer is an acrylate pressure-sensitive adhesive, and the thickness of the mounting adhesive layer is 10 μm-20 μm. In some embodiments, the thickness of mounting adhesive layer is 12 μm-15 μm. In some embodiments, the peel force of mounting adhesive layer is 5N-20N. In some embodiments, the peel force of mounting adhesive layer is 10N-15N.

In some embodiments, the release film is a PET film treated with a fluorine- or silicon-coated release agent, wherein the thickness of release film is 10 μm-50 μm. In some embodiments, the thickness of the release film is 20 μm-40 μm. In some embodiments, the release force of release film is 0.05N-0.15N. In some embodiments, the release force of release film is 0.08N-0.12N; and the residual adhesion rate of release film is greater than 85%. In some embodiments, the residual adhesion rate of release film is greater than 90%.

In some embodiments, the water-based polyurethane acrylate oligomer is a water-based aliphatic polyurethane acrylic resin, wherein the mass percentage of water-based polyurethane acrylate oligomer in the anion-hardening coating layer is 15 wt %-80 wt %. In some embodiments, the mass percentage of water-based polyurethane acrylate oligomer in the anion-hardening coating layer is 30 wt %-60 wt %.

In some embodiments, the photoinitiator is one of water-based benzion derivatives, water-based benzil derivatives, and alkylaryl ketone derivatives. In some embodiments, the photoinitiator is 2-hydroxy-2-methyl-phenylacetone, wherein the mass percentage of the photoinitiator in anion-hardening coating layer is 1 wt %-10 wt %. In some embodiments, the mass percentage of the photoinitiator in the anion-hardening coating layer is 2 wt %-6 wt %.

The present disclosure also provides a method of preparing an anionic explosion-proof membrane, wherein the method comprises the following steps:
after weighing the raw materials, adding a certain proportion of deionized water or distilled water and evenly mixing by a high-speed mixer;
applying one layer of anion-hardening coating on one side of the base film by roll coating or blade coating, then drying and curing by ultraviolet (UV), after that applying a second layer of anion-hardening coating on the surface thereof in the same manner, drying and curing by ultraviolet (UV), so as to obtain a base film with anion-hardening coating layer; and
coating mounting adhesive on the other side of the base film, and compounding with the release film, so as to obtain the anionic explosion-proof membrane.

The present disclosure provides a method of preparing an anionic explosion-proof membrane, wherein the method comprises the following steps:
mixing the water-based polyurethane acrylate oligomer, photoinitiator, anion agent, and water and stirring to obtain a first anion-hardening coating mixture and a second anion-hardening coating mixture, wherein
the amount of water-based anions in the first anion-hardening coating mixture is less than the amount of water-based anions in the second anion-hardening coating mixture; and
the particle diameter of the water-based anions in the first anion-hardening coating mixture is smaller than the particle diameter of the water-based anions in the second anion-hardening coating mixture;
coating the first anion-hardening coating mixture on one side of the base film, drying and curing to obtain the first anion-hardening coating layer;
coating the second anion-hardening coating mixture on the first anion-hardening coating layer, drying and curing to obtain the second anion-hardening coating layer; and
coating the mounting adhesive on the other side of the base film and compounding with a release film to obtain an anionic explosion-proof membrane.

In some embodiments, the thickness of the first anion-hardening coating layer is 1 μm-5 μm; the particle diameter of the anion agent in the first anion-hardening coating layer is 20 nm-60 nm; and the mass percentage of the anion agent in the first anion-hardening coating layer is 0.01%-0.1 wt %. In some embodiments, the particle diameter of the anion agent in the first anion-hardening coating layer is 20 nm-40 nm.

In some embodiments, the thickness of the second anion-hardening coating layer is 1 μm-5 μm; the particle diameter of the anion agent in the second anion-hardening coating layer is 70 nm-120 nm; and the mass percentage of the anion agent in the second anion-hardening coating layer is 0.2%-0.5 wt %. In some embodiments, the particle diameter of the anion agent in the second anion-hardening coating layer is 80 nm-100 nm.

In order to more clearly illustrate the implementation of the present disclosure, the drawings to be used in the description of the embodiments will be briefly described below, and it is obvious that the drawings in the following description are only some of the embodiments of the present disclosure, and that other drawings can be obtained based on these drawings by a person of ordinary skill in the art, without inventive effort.

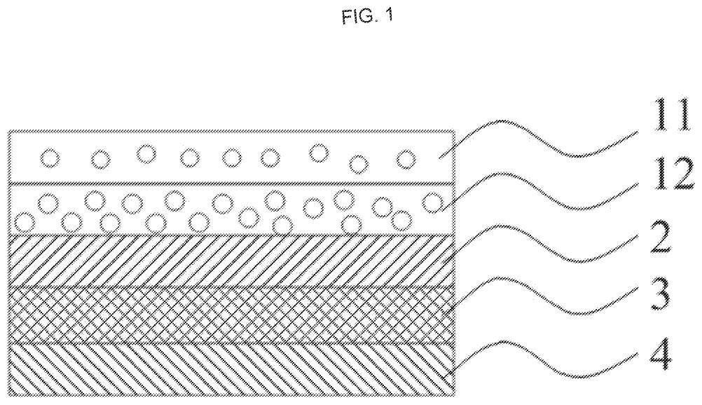

FIG. 1 is a structural schematic view of the anionic explosion-proof membrane.

### REFERENCE NUMERALS

11—first anion-hardening coating layer, 12—second anion-hardening coating layer, 2—base film, 3—mounting adhesive layer, 4—release film.

Embodiments of the present disclosure are described in detail below. Obviously, the described embodiments and examples are only a part of the embodiments and examples of the present disclosure and are not an exhaustive list of all embodiments and examples. It is to be noted that the embodiments and the features in the embodiments in the present disclosure can be combined with each other, and the examples and the features in the examples can be combined with each other, provided that there is no conflict.

The terms “first”, “second”, etc. as used in the specification and claims, if present, are used to distinguish similar objects and not necessary to be used to describe a particular order or sequence. It should be understood that the data such used can be interchangeable in appropriate cases, so that the examples described herein can be implemented in an order other than what is illustrated or described herein. In addition, the terms “include” and “comprise”, and any variations thereof, are intended to cover non-exclusive inclusion, for example, a process, method, system, product, or device comprising a series of steps or units is not necessarily limited to those steps or units explicitly listed, but can include other steps or units not explicitly listed or inherent in the process, method, product or device.

It should be understood that the term “and/or” as used herein is a description of an association relationship of associated objects, indicating that three relationships may exist, e.g., A and/or B, which can be expressed as A alone, both A and B, and B alone. In addition, the character “/” herein generally indicates an “or” relationship between the objects associated before and after.

### Embodiments of the Invention

Embodiments of the present disclosure provide an anionic explosion-proof membrane that efficiently and permanently releases anions.

In some embodiments, two layers of hardening coating layers are applied to one side surface of the base film, wherein each of the two layers of hardening coating layers contains anion agent of different concentrations and particle diameters. In some embodiments, the anion-hardening coating layer close to the base film has a higher concentration of anion agent and larger particle diameter, while the anion-hardening coating layer away from the base film has a lower concentration of anion agent and smaller particle diameter. It is believed that, free of theoretical constraints, this design solution takes advantage of the concentration gradient formed by the anion agent between the two layers of anion-hardening coating layers, which provides migration momentum for particles of anion agent, from areas of high concentration to areas of low concentration. At the same time, due to the larger particle diameter of the anion agent in the anion-hardening coating layer close to the base film, the migration resistance is larger, which reduces the migration rate of the anion agent, thereby extending the effect of the release of anion in the surface layer; while the particle diameter of anion agent in the anion-hardening coating layer away from the base film is smaller, which is favorable for the migration of anion agent to the outermost layer and plays the role of releasing anion. By configuring two layers of anion-hardening coating layers with different particle diameters and concentrations of anion agents, such that the explosion-proof membrane has efficient and long-lasting anion release capability.

As shown in FIG. 1, an anionic explosion-proof membrane includes a first anion-hardening coating layer 11 and a second anion-hardening coating layer 12 adjacent to each other in sequence, a base film 2, a mounting adhesive layer 3, and a release film 4.

Both the first anion-hardening coating layer 11 and the second anion-hardening coating layer 12 contain the water-based polyurethane acrylate oligomer, photoinitiator, anion agent, and water.

The amount of water-based anions in the first anion-hardening coating layer 11 is less than the amount of water-based anions in the second anion-hardening coating layer 12.

The particle diameter of the water-based anions of the first anion-hardening coating layer 11 is smaller than the particle diameter of the water-based anions in the second anion-hardening coating layer 12.

In some embodiments, the material of base film is PET. In some embodiments, the thickness of the base film can be 20 μm-200 μm. In some embodiments, the thickness of the base film can be, for example, 50 μm-180 μm, 70 μm-150 μm, or 90 μm-120 μm, such as 20 μm, 40 μm, 60 μm, 80 μm, 100 μm, 120 μm, 140 μm, 160 μm, 180 μm, 200 μm. In some embodiments, the base film is a PET film with a thickness of 50 μm-100 μm. In some embodiments, the base film has a light transmittance of 85% or more. In some embodiments, the light transmittance of base film can be, for example, 85%-99%, 87%-95%, or 89%-92%, such as 85%, 87%, 90%, 92%, 94%, 96%, 98%, or 99%. In some embodiments, the base film is a PET film with a light transmittance of 90% or more.

In some embodiments, the material of the mounting adhesive layer is an acrylate pressure-sensitive adhesive. In some embodiments, the thickness of the mounting adhesive layer can be 10 μm-20 μm. In some embodiments, the thickness of the mounting adhesive layer can be 11 μm-18 μm, 11.5 μm-17 μm, 12 μm-15 μm, or 13 μm-14 μm, such as 10 μm, 12 μm, 14 μm, 16 μm, 18 μm, and 20 μm. In some embodiments, the peel force of the mounting adhesive layer is 5N-20N. In some embodiments, the peel force of acrylate pressure-sensitive adhesive can be 7N-18N, 10N-15N, or 12N-14N.

In some embodiments, the release film is a PET film treated with a fluorine- or silicon-coated release agent. In some embodiments, the thickness of the release film can be 10 μm-50 μm. In some embodiments, the thickness of the release film can be 15 μm-45 μm, 20 μm-40 μm, 25 μm-35 μm, or 28 μm-32 μm. In some embodiments, the release force of the release film is 0.05N-0.15N. In some embodiments, the release force of the release film can be 0.06N-0.13N, 0.08N-0.12N, or 0.09N-0.11N. In some embodiments, the residual adhesion rate of the release film is greater than 85%. In some embodiments, the residual adhesion rate is greater than 90%.

In some embodiments, the total thickness of anion-hardening coating layer is 2 μm-10 μm. In some embodiments, the thickness of anion-hardening coating layer 11 is 1 μm-5 μm, for example, 1.5 μm-4.5 μm, 2 μm-4 μm, or 2.5 μm-3.5 μm, such as 1 μm, 1.5 μm, 2 μm, 2.5 μm, 3 μm, 3.5 μm, 4 μm, 4.5 μm, or 5 μm. In some embodiments, the thickness of anion-hardening coating layer 12 is 1 μm-5 μm, for example, 1.5 μm-4.5 μm, 2 μm-4 μm, or 2.5 μm-3.5 μm, such as 1 μm, 1.5 μm, 2 μm, 2.5 μm, 3 μm, 3.5 μm, 4 μm, 4.5 μm, or 5 μm.

In some embodiments, the anion-hardening coating layer comprises the following components: water-based polyurethane acrylate oligomer, photoinitiator, anion agent, and deionized water or distilled water.

In some embodiments, the water-based polyurethane acrylate oligomer used is a water-based aliphatic polyurethane acrylic resin. In some embodiments, water-based aliphatic polyurethane acrylic resins can adopt the following products: one or two of Changxing's 6166W, DR-W425, DR-W450, DR-W470, DR-W482, DR-W495, DR-W402S, DR-W413S, and DR-W485S. In some embodiments, the water-based polyurethane acrylic resin in the anion-hardening coating layer has a mass percentage of 15 wt %-80 wt %. In some embodiments, the percentage of the water-based polyurethane acrylic resin in the anion-hardening coating layer is, for example, 20 wt %-75 wt %, 25 wt %-70 wt %, 30 wt %-60 wt %, or 35 wt %-55 wt %, such as 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, or 80 wt %.

In some embodiments, the photoinitiator is one of the water-based benzoin derivatives, water-based benzil derivatives, and alkylaryl ketone derivatives. In some embodiments, the photoinitiator is 2-hydroxy-2-methyl-phenylpropanone (1173) of alkylaryl ketone derivative. In some embodiments, the mass percentage of photoinitiator in the anion-hardening coating layer is 1 wt %-10 wt %. In some embodiments, the mass percentage of photoinitiator in the anion-hardening coating layer is, for example, 1.5 wt %-8 wt %, 2 wt %-7 wt %, 2 wt %-6 wt % or 3 wt %-5 wt %, such as 1 wt %, 2 wt %, 3 wt %, 4 wt %, 5 wt %, 6 wt %, 7 wt %, 8 wt %, 9 wt %, or 10 wt %.

In some embodiments, the anion agent is prepared from the natural mineral tourmaline by means of ultrafine pulverization, coating modification, and ion exchange doping. In some embodiments, the range of particle diameter of anion agent is 20 nm-120 nm, for example, 30 nm-110 nm, 40 nm-100 nm, or 50 nm-90 nm, such as 20 nm, 30 nm, 40 nm, 50 nm, 60 nm, 70 nm, 80 nm, 90 nm, 100 nm, 110 nm, or 120 nm.

In some embodiments, the thickness of the first anion-hardening coating layer is 1 μm-5 μm, for example, 1.5 μm-4.5 μm, 2 μm-4 μm, or 2.5 μm-3.5 μm, such as 1 μm, 1.5 μm, 2 μm, 2.5 μm, 3 μm, 3.5 μm, 4 μm, 4.5 μm, or 5 μm. In some embodiments, the particle diameter of the anion agent in the first anion-hardening coating layer is 20 nm-60 nm, for example, the particle diameter is 20 nm-50 nm, 20 nm-40 nm, 25 nm-35 nm, or 20 nm-25 nm, such as 20 nm, 25 nm, 30 nm, 35 nm, 40 nm, 45 nm, 50 nm, 55 nm, or 60 nm. In some embodiments, the mass percentage of anion agent in the first anion-hardening coating layer is 0.01 wt %-0.1 wt %, for example, the mass percentage is 0.02 wt %-0.08 wt %, 0.03 wt %-0.07 wt %, or 0.04 wt %-0.06 wt %, such as 0.01 wt %, 0.02 wt %, 0.03 wt %, 0.04 wt %, 0.05 wt %, 0.06 wt %, 0.07 wt %, 0.08 wt %, 0.09 wt %, or 0.1 wt %. In some embodiments, the thickness of second anion-hardening coating layer is 1 μm-5 μm, for example, 1.5 μm-4.5 μm, 2 μm-4 um, or 2.5 μm-3.5 μm, such as 1 μm, 1.5 μm, 2 μm, 2.5 μm, 3 μm, 3.5 μm, 4 μm, 4.5 μm, or 5 μm. In some embodiments, the particle diameter of the anion agent in the second anion-hardening coating layer is 70 nm-120 nm, for example, the particle diameter can be 75 nm-110 nm, 80 nm-100 nm, 80 nm-90 nm, or 85 nm-90 nm, such as 70 nm, 80 nm, 90 nm, 100 nm, or 110 nm. In some embodiments, the mass percentage of the anion agent in the second anion-hardening coating layer is 0.2 wt %-0.5 wt %, for example, 0.24%-0.48 wt %, 0.26%-0.42 wt %, or 0.3%-0.4 wt %, such as 0.2 wt %, 0.25 wt %, 0.3 wt %, 0.35 wt %, 0.4 wt %, 0.45 wt %, or 0.5 wt %.

The method of preparing an anionic explosion-proof membrane provided by some embodiments of the present disclosure comprises the following steps:
after weighing the raw materials, adding a certain proportion of deionized water or distilled water, and mixing evenly by a high-speed mixer; applying one layer of anion-hardening coating on one side of the base film by roll coating or blade coating, then drying and curing by ultraviolet (UV), after that applying a second layer of anion-hardening coating is on the surface thereof in the same manner, drying and curing by ultraviolet (UV), so as to obtain a base film with anion-hardening coating layer; coating the mounting adhesive on the other side of the base film and compounding with the release film to obtain anionic explosion-proof membrane.

Some embodiments of the present disclosure provide a preparation method for an anionic explosion-proof membrane, comprising the following steps:
mixing and stirring the water-based polyurethane acrylate oligomer, photoinitiator, anion agent and water, to obtain a first anion-hardening coating mixture and a second anion-hardening coating mixture, wherein
the amount of water-based anions in the first anion-hardening coating mixture is less than the amount of water-based anions in the second anion-hardening coating mixture; and
the particle diameter of the water-based anions in the first anion-hardening coating mixture is smaller than the particle diameter of the water-based anions in the second anion-hardening coating mixture;
applying the first anion-hardening coating mixture on one side of the base film, drying and curing to obtain the first anion-hardening coating layer;
applying the second anion-hardening coating mixture on the first anion-hardening coating layer, drying and curing to obtain the second anion-hardening coating layer; and
coating the mounting adhesive on the other side of the base film and compounding with the release film to obtain the anionic explosion-proof membrane.

In some embodiments, the thickness of the first anion-hardening coating layer is 1 μm-5 μm; the particle diameter of the anion agent in the first anion-hardening coating layer is 20 nm-60 nm; and the mass percentage of the anion agent in the first anion-hardening coating layer is 0.01%-0.1 wt %. In some embodiments, the particle diameter of the anion agent in the first anion-hardening coating layer is 20 nm-40 nm.

In some embodiments, the thickness of the second anion-hardening coating layer is 1 μm-5 μm; the particle diameter of the anion agent in the second anion-hardening coating layer is 70 nm-120 nm; and the mass percentage of the anion agent in the second anion-hardening coating layer is 0.2%-0.5 wt %. In some embodiments, the particle diameter of the anion agent in the second anion-hardening coating layer is 80 nm-100 nm.

The present disclosure provides an anionic explosion-proof membrane that enables the explosion-proof membrane attached to a bathroom glass to have the ability to release anions, which can play a role in killing bacteria in the bathing environment and purifying the air. The principle of this anti-bacterial effect is grinding the anion mineral crystals into nano-sized anion agent, adding the resultant to the hardening agent, and coating on the surface of optical-grade PET, so as to obtain a hardening coating layer with anionic function. The anions are generated through ionization of water molecules adsorbed on the surface of the membrane, and the anions combine with the oxygen molecules in the air to generate negative oxygen ions, thus effectively removing the formaldehyde and other harmful gases from the air and eliminating the bacteria.

At the same time, the anionic explosion-proof membrane of the present disclosure has basic functions such as good wear resistance, high hardness, and preventing the glass from bursting and hurting people, and also has an efficient and long-lasting anion release function, thereby providing people with a lasting safe, healthy and hygienic environment.

### 4. Examples

The present disclosure will be described below through specific embodiments.

In order to compare the release concentration of anion and release persistence of explosion-proof membranes coated with one anion-hardening coating layer and two anion-hardening coating layers, under the premise that the content of the anion agent in the anion-hardening coating layer of the membrane sample per unit area is equivalent, the membranes in the Examples and Comparative Examples below were made.

### Example 1

Ingredients composition: the total thickness of the anion-hardening coating layer was 6 μm, wherein the thickness of second anion-hardening coating layer 12 was 3 μm, the mass percentage of the anion agent was 0.4%, and the particle diameter of the anion agent was 80 nm-90 nm; and the thickness of first anion-hardening coating layer 11 was 3 μm, a mass percentage of the anion agent was 0.05%, and a particle diameter of the anion agent was 20 nm-25 nm. In this Example, the component contents of the first anion-hardening coating layer 11 and the second anion-hardening coating layer 12 are shown in Table 1.

TABLE 1
Example Component Contents

| | The mass | The mass |
|---|---|---|
| | percentage of | percentage of |
| | each component | each component |
| | in the second anion- | in the first anion- |
| | hardening coating | hardening coating |
| Component | layer 12 | layer 11 |
| DR-W413S | 20% | 20% |
| DR-W470 | 25% | 25% |
| Deionized water | 55% | 55% |
| 1173 | 2% | 2% |
| anion agent | 0.4% | 0.05% |

Preparation method included the following steps: weighing the components according to Table 1 and mixing them evenly with a high-speed mixer to obtain the anion-hardening liquid; coating the anion-hardening liquid on a PET base film with a thickness of 50 μm through a micro-concave roller, wherein the thickness of second anion-hardening coating layer 12 was 3 μm; after drying at 100° C., illuminating by the UV light at the speed of 15 m/min, wherein the irradiation intensity was 400 mJ/c m², and curing to obtain the anion-hardening film; coating to obtain the first anion-hardening coating layer 11 with the thickness of 3 μm by the same process; and coating the other side of the PET film with mounting adhesive through a micro-concave roller, wherein the thickness of the mounting adhesive layer was 15 μm, and after drying at 110° C., compounding with the release film of a thickness of 25 μm, so as to obtain the anionic explosion-proof membrane.

### Example 2

Ingredients composition: the total thickness of the anion-hardening coating was 6 μm, wherein the thickness of second anion-hardening coating layer 12 was 3 μm, a mass percentage of the anion agent was 0.3%, and a particle diameter of the anion agent was 90 nm-95 nm; and the thickness of first anion-hardening coating layer 11 was 3 μm, a mass percentage of the anion agent was 0.03%, and a particle diameter of the anion agent was 25 nm-30 nm. In this Example, the component contents of the first anion-hardening coating layer 11 and the second anion-hardening coating layer 12 are shown in Table 2.

TABLE 2
Example Component Contents

| | The mass | The mass |
|---|---|---|
| | percentage of | percentage of |
| | each component | each component |
| | in the second anion- | in the first anion- |
| | hardening coating | hardening coating |
| Component | layer 12 | layer 11 |
| DR-W413S | 20% | 20% |
| DR-W470 | 25% | 25% |
| deionized water | 55% | 55% |
| 1173 | 2% | 2% |
| anion agent | 0.3% | 0.03% |

Preparation method: the components were weighed according to Table 2, and the preparation of the explosion-proof membrane was carried out in the same way as in Example 1.

### Example 3

Ingredients composition: the total thickness of the anion-hardening coating layer was 6 μm, wherein the thickness of second anion-hardening coating layer 12 was 3 μm, the mass percentage of the anion agent was 0.5%, and the particle diameter of the anion agent was 95 nm-100 nm; and the thickness of first anion-hardening coating layer 11 was 3 μm, a mass percentage of the anion agent was 0.08%, and a particle diameter of the anion agent was 35 nm-40 nm. In this Example, the component contents of the first anion-hardening coating layer 11 and the second anion-hardening coating layer 12 are shown in Table 3.

TABLE 3
Example Component Contents

| | The mass | The mass |
|---|---|---|
| | percentage of | percentage of |
| | each component | each component |
| | in the second anion- | in the first anion- |
| | hardening coating | hardening coating |
| Component | layer 12 | layer 11 |
| DR-W413S | 20% | 20% |
| DR-W470 | 25% | 25% |
| deionized water | 55% | 55% |
| 1173 | 2% | 2% |
| anion agent | 0.5% | 0.08% |

Preparation method: the components were weighed according to Table 3, and the preparation of the explosion-proof membrane was carried out in the same way as in Example 1.

### Comparative Example 1

Table 4 lists the components in the anion-hardening coating layer and the mass percentage of each component of Comparative Example 1. The thickness of the anion-hardening coating layer in Comparative Example 1 was 6 μm, the additional amount of the anion agent was 0.45%, and the particle diameter of the anion agent was 20 nm-25 nm; the process conditions and methods for making the anionic explosion-proof membrane of Comparative Example 1 were the same as those of Example 1. The only difference was that only one anion-hardening coating layer was applied.

TABLE 4
Comparative Example Component Contents

| | The mass percentage of each |
|---|---|
| | component in the anion- |
| Component | hardening coating layer |
| DR-413S | 20% |
| DR-470 | 25% |
| deionized water | 55% |
| 1173 | Extra 2% |
| anion agent | Extra 0.45% |

### Comparative Example 2

The composition of each component and the mass percentage of each component of the anion-hardening coating layers of Comparative Example 2 and Comparative Example 1 were the same, the difference was that the particle diameter of the water-based anions in the anion-hardening coating layer of Comparative Example 2 was 80 nm-90 nm. Only one anion-hardening coating layer was coated in Comparative Example 2.

According to the method specified in JC/T2040-2010, the anionic explosion-proof membranes prepared in Examples 1-3, Comparative Example 1 and Comparative Example 2 were tested, so as to obtain its concentration of anion released and change of concentration along with standing time. The test results are shown in Table 5.

TABLE 5
Example and Comparative Example Testing Results

| Standing day | 1 day | 15 days | 30 days | 60 days |
|---|---|---|---|---|
| Example 1 | 963 | 951 | 968 | 972 |
| Per(s⁻¹ · cm⁻²) | | | | |
| Example 2 | 958 | 952 | 956 | 961 |
| Per(s⁻¹ · cm⁻²) | | | | |
| Example 3 | 968 | 971 | 978 | 973 |
| Per(s⁻¹ · cm⁻²) | | | | |
| Comparative Example 1 | 976 | 920 | 832 | 751 |
| Per(s⁻¹ · cm⁻²) | | | | |
| Comparative Example 2 | 687 | 650 | 631 | 624 |
| Per(s⁻¹ · cm⁻²) | | | | |

By comparing Example 1 with Comparative Example 1 and Comparative Example 2, in the case that the content of anion agent in the anion-hardening coating layer per unit area of membrane sample is equivalent, Example 1 and Comparative Example 1 have close initial release concentration of anion, but Example 1 has better persistence. This is because the anion agent in the anion-hardening coating layer needs to migrate to the surface of the membrane to play a role in releasing anions, whereas the anion agent in Example 1 has a certain concentration gradient, which prolongs the effective action time of the anion agent. That is, the anion agent at the surface of layer is enough to provide instant anion releasing capacity, and when the inner layer contains a higher concentration of anion agent, a better durability can be achieved through constant migration to the outer layer.

### Examples 4-6

In order to examine the durability of the anion releasing effect when the first anion-hardening coating layer 11 and the second anion-hardening coating layer 12 contained anion agents of different particle diameters, the anionic explosion-proof membranes in Examples 4-6 were made. What is different from Example 1 was the particle size of the anion agent in Example 4-6. The types and contents of the remaining components and the concentration gradient of the anion agent in the anion-hardening coating layer and the production process were all the same.

### Example 4

The total thickness of the anion-hardening coating was 6 μm, wherein the thickness of second anion-hardening coating layer 12 was 3 μm, the content of anion agent was 0.4%, and the particle diameter of anion agent was 20 nm-25 nm; and the thickness of first anion-hardening coating layer 11 was 3 μm, the content of anion agent was 0.05%, and particle diameter thereof was 20 nm-25 nm. Except for the difference in the content and particle diameter of the anion agent, the composition and content of the other components of each anion-hardening coating layer were the same as the components shown in Table 1 in Example 1.

### Example 5

The total thickness of the anion-hardening coating layer was 6 μm, wherein the thickness of second anion-hardening coating layer 12 was 3 μm, the content of anion agent was 0.4%, and the particle diameter of anion agent was 80 nm-90 nm; and the thickness of first anion-hardening coating layer 11 was 3 μm, the content of anion agent was 0.05%, and particle diameter thereof was 80 nm-90 nm. Except for the difference in the content and particle diameter of the anion agent, the composition and content of the other components of each anion-hardening coating layer were the same as the components shown in Table 1 in Example 1.

### Example 6

The total thickness of the anion-hardening coating layer was 6 μm, wherein the thickness of second anion-hardening coating layer 12 was 3 μm, the content of anion agent was 0.4%, and the particle diameter of anion agent was 20 nm-25 nm; and the thickness of first anion-hardening coating layer 11 was 3 μm, the content of anion agent was 0.05%, and particle diameter thereof was 80 nm-90 nm. Except for the difference in the content and particle diameter of the anion agent, the composition and content of the other components of each anion-hardening coating layer were the same as the components shown in Table 1 in Example 1.

The prepared anionic explosion-proof membrane was tested for its concentration of released anions and its change along with the placement time according to the method specified in JC/T2040-2010. The test results are shown in Table 6.

TABLE 6
Results for Concentration of Released Anions

| Standing day | 1 day | 15 days | 30 days | 60 days |
|---|---|---|---|---|
| Example 1 | 963 | 951 | 968 | 972 |
| Per(s⁻¹ · cm⁻²) | | | | |
| Example 4 | 932 | 993 | 904 | 851 |
| Per(s⁻¹ · cm⁻²) | | | | |
| Example 5 | 602 | 652 | 683 | 672 |
| Per(s⁻¹ · cm⁻²) | | | | |
| Example 6 | 610 | 706 | 813 | 762 |
| Per(s⁻¹ · cm⁻²) | | | | |

From Table 6, it can be seen that the migration rate of the anion agent particles is related to the size of the particles, with the particles of small particle diameters migrating quickly and the particles of large particle diameters migrating slowly. It can be seen by comparing Example 1 with Examples 4 to 6 that in Example 1, the anion agent with large particle diameter is distributed in a layer close to the base film (which is the inner layer), and the anion agent with small particle diameter is distributed in a layer away from the base film (which is the outer layer), which has a higher initial concentration of anion released and better durability; in Example 4, the inner layer and the outer layer are both anion agent with small particle diameter, which have a high initial concentration of anion released but low durability; in Example 5, the inner layer and outer layer both have anion agent with large particle diameter, which has a high persistence of anion release but low concentration of anion release; and in Example 6, the anion agent with small particle diameter was distributed in the inner layer and the anion agent with large particle diameter was distributed in the outer layer, which has a low initial concentration of anion released and medium persistence of anion release. Therefore, the anion-hardening coating layer is coated as two layers, and the anion agent contained in these two layers has a concentration gradient, wherein the inner layer has anion agent of larger particle diameter, and the outer layer is distributed with anion agent of smaller particle diameter, so as to provide efficient ability of anion release for the anionic explosion-proof membrane, and also to enable better durability.

The above embodiments of the present disclosure are only for a clear description of Examples of the present disclosure, not to limit the implementation of the present disclosure. For those of ordinary skill in the art, on the basis of the above description, other different forms of changes or changes can also be made. It is not possible to exhaustively list all the embodiments herein, and any obvious changes or modifications derived from the technical solutions of the present disclosure are still within the scope of protection of the present disclosure.

### 6. Industrial Applicability

The present disclosure provides an anionic explosion-proof membrane and a preparation method therefor The anionic explosion-proof membrane has basic functions such as good wear resistance, high hardness, and preventing glass from bursting and hurting people, and at the same time, also has an efficient and long-lasting anion release function, so as to provide people with a durable safe, healthy and hygienic environment, thereby having excellent industrial applicability.

1. An anionic explosion-proof membrane, comprising:
(a) a first anion-hardening coating layer and a second anion-hardening coating layer adjacent to each other in sequence,
(b) a base film,
(c) a mounting adhesive layer, and
(d) a release film,
wherein the first anion-hardening coating layer and the second anion-hardening coating layer both contain a water-based polyurethane acrylate oligomer, a photoinitiator, a water-based anion agent, and water,
wherein the amount of water-based anions in the first anion-hardening coating layer is less than an amount of water-based anions in the second anion-hardening coating layer, and
wherein the particle diameter of the water-based anions in the first anion-hardening coating layer is smaller than the particle diameter of the water-based anions in the second anion-hardening coating layer.

2. The anionic explosion-proof membrane according to claim 1, wherein the total thickness of the first anion-hardening coating layer and the second anion-hardening coating layer is 2 μm-10 μm.

3. The anionic explosion-proof membrane according to claim 1, wherein a thickness of the first anion-hardening coating layer is 1 μm-5 μm; the particle diameter of the water-based anion agent in the first anion-hardening coating is 20 nm-60 nm; and the mass percentage of the water-based anion agent in the first anion-hardening coating layer is 0.01 wt %-0.1 wt %.

4. The anionic explosion-proof membrane according to claim 1, wherein the thickness of the second anion-hardening coating layer is 1 μm-5 μm; the particle diameter of the water-based anion agent in the second anion-hardening coating layer is 70 nm-120 nm; and the mass percentage of the water-based anion agent in the second anion-hardening coating layer is 0.2 wt %-0.5 wt %.

5. The anionic explosion-proof membrane according to claim 1, wherein the water-based anion agent is prepared from a natural mineral tourmaline by ultrafine pulverization, coating modification, and ion exchange doping.

6. The anionic explosion-proof membrane according to claim 1, wherein the base film comprises PET, and the thickness of the base film is 20 μm-200 μm; and the light transmittance of the base film is more than 85%.

7. The anionic explosion-proof membrane according to claim 1, wherein the mounting adhesive layer comprises an acrylate pressure-sensitive adhesive, the thickness of the mounting adhesive layer is 10 μm-20 μm; and the peeling force of the mounting adhesive layer is 5 N-20 N.

8. The anionic explosion-proof membrane according to claim 1, wherein the release film is a PET film treated with a fluorine- or silicon-coated release agent, the thickness of the release film is 10 μm-50 μm; the release force of the release film is 0.05 N-0.15 N; and the residual adhesion rate of the release film is greater than 85%.

9. The anionic explosion-proof membrane according to claim 1, wherein the water-based polyurethane acrylate oligomer is a water-based aliphatic polyurethane acrylic resin; and the mass percentage of the water-based polyurethane acrylate oligomer in the anion-hardening coating layer is 15%-80 wt %.

10. The anionic explosion-proof membrane according to claim 1, wherein the photoinitiator is selected from the group consisting of water-based benzoin derivatives, water-based benzil derivatives, and alkylaryl ketone derivatives; and the mass percentage of the photoinitiator in the anion-hardening coating layer is 1 wt %-10 wt %.

11. A preparation method for an anionic explosion-proof membrane comprising:
(a) after weighing raw materials, adding deionized water or distilled water, and mixing evenly by a high-speed mixer;
(b) applying one layer of anion-hardening coating on one side of the base film by roll coating or a blade coating;
(c) drying the coating and curing by ultraviolet (UV) light;
(d) applying a second layer of anion-hardening coating on the surface thereof in the same manner, drying and curing by UV, so as to obtain a base film with an anion-hardening coating layer; and
(e) coating a mounting adhesive on the other side of the base film and compounding with a release film to obtain the anionic explosion-proof membrane.

12. A preparation method for an anionic explosion-proof membrane, comprising:
(a) mixing and stirring a water-based polyurethane acrylate oligomer, a photoinitiator, a water-based anion agent and water, to obtain a first anion-hardening coating mixture and separately mixing and stirring a water-based polyurethane acrylate oligomer, a photoinitiator, a water-based anion agent and water to obtain a second anion-hardening coating mixture, wherein the amount of water-based anions in the first anion-hardening coating mixture is less than the amount of water-based anions in the second anion-hardening coating mixture; and the particle diameter of the water-based anions in the first anion-hardening coating mixture is smaller than the particle diameter of the water-based anions in the second anion-hardening coating mixture;
(b) to a base film having a first side and a second side, applying the first anion-hardening coating mixture on the first side of the base film, drying and curing to obtain a first anion-hardening coating layer; and applying the second anion-hardening coating mixture on the first anion-hardening coating layer, drying and curing to obtain a second anion-hardening coating layer; and
(c) coating a mounting adhesive on the second side of the base film and compounding with a release film to obtain the anionic explosion-proof membrane.

13. The preparation method according to claim 12, wherein the thickness of the first anion-hardening coating layer is 1 μm-5 μm; the particle diameter of the water-based anion agent in the first anion-hardening coating layer is 20 nm-60 nm; and the mass percentage of the water-based anion agent in the first anion-hardening coating layer is 0.01 wt %-0.1 wt %.

14. The preparation method according to claim 12, wherein the thickness of the second anion-hardening coating layer is 1 μm-5 μm; the particle diameter of the water-based anion agent in the second anion-hardening coating layer is 70 nm-120 nm; and the mass percentage of the water-based anion agent in the second anion-hardening coating layer is 0.2 wt %-0.5 wt %.

15. The anionic explosion-proof membrane according to claim 2, wherein the thickness of the second anion-hardening coating layer is 1 μm-5 μm; the particle diameter of the water-based anions in the second anion-hardening coating layer is 70 nm-120 nm; preferably, the particle diameter is 80 nm-100 nm; and the mass percentage of the water-based anions in the second anion-hardening coating layer is 0.2 wt %-0.5 wt %.

16. The anionic explosion-proof membrane according to claim 2, wherein the water-based anions is prepared from a natural mineral tourmaline by ultrafine pulverization, coating modification, and ion exchange doping.

17. The anionic explosion-proof membrane according to claim 2, wherein the base film comprises PET, and the thickness of the base film is 20 μm-200 μm; the thickness of the base film is 50 μm-100 μm; and the light transmittance of the base film is more than 90%.

18. The anionic explosion-proof membrane according to claim 2, wherein a material of the mounting adhesive layer is an acrylate pressure-sensitive adhesive, and the thickness of the mounting adhesive layer is 12 μm-15 μm; and the peeling force of the mounting adhesive layer is 10 N-15 N.

19. The anionic explosion-proof membrane according to claim 2, wherein the release film is a PET film treated with a fluorine- or silicon-coated release agent, the thickness of the release film is 20 μm-40 μm; the release force of the release film is 0.08N-0.12N; and the residual adhesion rate of the release film is greater than 90%.

20. The anionic explosion-proof membrane according to claim 2, wherein the water-based polyurethane acrylate oligomer is a water-based aliphatic polyurethane acrylic resin; and the mass percentage of the water-based polyurethane acrylate oligomer in the anion-hardening coating layer is 30 wt %-60 wt %.
